(19) United States
(12) Patent Application Publication
(10) Pub. No.: US 2025/0390061 A1
(43) Pub. Date: Dec. 25, 2025

(54) METHOD FOR WRITING INFORMATION TO CONSUMABLE, IMAGE FORMING APPARATUS, CONSUMABLE, MANAGEMENT SYSTEM, AND SERVER

(71) Applicant: CANON KABUSHIKI KAISHA, Tokyo (JP)

(72) Inventor: SATORU MOTOHASHI, Chiba (JP)

(21) Appl. No.: 19/236,610

(22) Filed: Jun. 12, 2025

(30) Foreign Application Priority Data
Jun. 19, 2024 (JP) 2024-098976

(51) Int. Cl. G03G 21/18; G03G 15/00

(52) U.S. Cl. CPC G03G 21/1892; G03G 15/55; G03G 2215/00987; G03G 2221/1823

(57) ABSTRACT

A consumable can be attached to and removed from an image forming apparatus. An image forming unit forms an image on a sheet using the consumable. A controller controls the image forming unit using an image forming condition read out from a storage medium provided in the consumable. The storage medium includes a first storage area configured to store a first image forming condition applied to the image forming unit before the consumable is remanufactured, and a second storage area configured to store a second image forming condition that is written and applied to the image forming unit when the consumable is remanufactured.

### BACKGROUND

### Field of the Technology

The present disclosure relates to a method for writing information to a consumable, an image forming apparatus, a consumable, a management system, and a server.

### Description of the Related Art

An electrophotographic image forming apparatus forms an image on a sheet using a removable process cartridge. A process cartridge sometimes includes a non-volatile memory. According to Japanese Patent Laid-Open No. 2007-240928, the non-volatile memory stores image forming conditions suited to that process cartridge. Additionally, Japanese Patent Laid-Open No. 2005-195900 describes a non-volatile memory storing information that distinguishes genuine products from non-genuine products, and malfunctions in an image forming apparatus are prevented by restricting a usage period of non-genuine process cartridges. Furthermore, according to Japanese Patent Laid-Open No. 2005-070254, process cartridges having the same specifications can be used in a plurality of different image forming apparatuses, and a non-volatile memory stores image forming conditions suited to each image forming apparatus.

Incidentally, to improve the environmental performance of an image forming apparatus, used process cartridges may be collected from users and reused (remanufactured). For example, a process cartridge is refilled with toner, parts of the process cartridge are replaced with new ones, or the like, and the process cartridge is then resold. Such remanufacturing may be performed not only by the genuine product manufacturing company that manufactures the image forming apparatus, but also by a third party (a remanufacturing company). A genuine product manufacturing company can remanufacture process cartridges using genuine parts. Accordingly, the image forming conditions suited to a process cartridge remanufactured by a genuine product manufacturing company are consistent with the image forming conditions from before the remanufacturing. On the other hand, a remanufacturing company remanufactures process cartridges by procuring parts different from those provided by a genuine product manufacturing company. Accordingly, the image forming conditions suited to a process cartridge remanufactured by a remanufacturing company may be different from the image forming conditions suited to a process cartridge remanufactured by a genuine product manufacturing company. When a process cartridge remanufactured by a remanufacturing company is used, decreases in image density, toner smudging, fixing problems, or the like may occur, and the image forming apparatus may malfunction. Previously, genuine product manufacturing companies were unaware of what parts remanufacturing companies use, and it was therefore not possible to know the image forming conditions suited to a process cartridge remanufactured by a remanufacturing company. Accordingly, a genuine product manufacturing company was unable to pre-write image forming conditions suited to a process cartridge remanufactured by a remanufacturing company to a non-volatile memory.

### SUMMARY

The present disclosure provides an image forming apparatus comprising:
a consumable that can be attached to and removed from the image forming apparatus; an image forming unit configured to form an image on a sheet using the consumable; and a controller configured to control the image forming unit using an image forming condition read out from a storage medium provided in the consumable, wherein the storage medium includes: a first storage area configured to store a first image forming condition applied to the image forming unit before the consumable is remanufactured; and a second storage area configured to store a second image forming condition that is written and applied to the image forming unit when the consumable is remanufactured.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are diagrams illustrating the main body of an image forming apparatus and a process cartridge.

FIGS. 2A and 2B are diagrams illustrating a storage device.

FIG. 3 is a diagram illustrating a management system.

FIG. 4 is a diagram illustrating a controller of the image forming apparatus.

FIGS. 5A to 5C are diagrams illustrating steps in remanufacturing.

FIG. 6 is a diagram illustrating coordination between a genuine product manufacturing company and a remanufacturing company.

FIG. 7 is a diagram illustrating a sequence from reselling to image forming.

FIG. 8 is a diagram illustrating a sequence from issuing an ID to writing image forming conditions.

FIGS. 9A and 9B are diagrams illustrating a server.

FIGS. 10A and 10B are diagrams illustrating a PC and a user device.

FIG. 11 is a diagram illustrating functions of a CPU of the image forming apparatus.

FIG. 12 is a diagram illustrating a storage device in which image forming conditions for a remanufactured product are written.

FIGS. 13A and 13B are diagrams illustrating a storage device in which image forming conditions for a remanufactured product are written.

FIG. 14 is a diagram illustrating a management system.

FIG. 15 is a diagram illustrating writing of an image forming condition.

FIGS. 16A and 16B are diagrams illustrating functions of CPUs of the server and the image forming apparatus.

FIG. 17 is a diagram illustrating a management system.

FIG. 18 is a diagram illustrating writing of an image forming condition.

FIG. 19 is a diagram illustrating a PC.

FIG. 20 is a diagram illustrating writing of an image forming condition.

FIG. 21 is a diagram illustrating a server.

FIG. 22 is a diagram illustrating a user device.

### DESCRIPTION OF THE EMB0 DIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a remanufacturing company (a secondary company (a remanufacturer)) remanufactures a consumable (e.g., a process cartridge) and applies to a genuine product manufacturing company (a primary company (a manufacturer)) to register image forming conditions. The genuine product manufacturing company presents a range of image forming conditions applicable to the image forming apparatus to the remanufacturing company. The remanufacturing company determines image forming conditions within the range and sends those image forming conditions to the genuine product manufacturing company. The genuine product manufacturing company uploads the image forming conditions to a server. When a remanufactured consumable is mounted, the image forming apparatus downloads and uses the image forming conditions from the server.

### 1. Configuration of Image Forming Apparatus and Process Cartridge

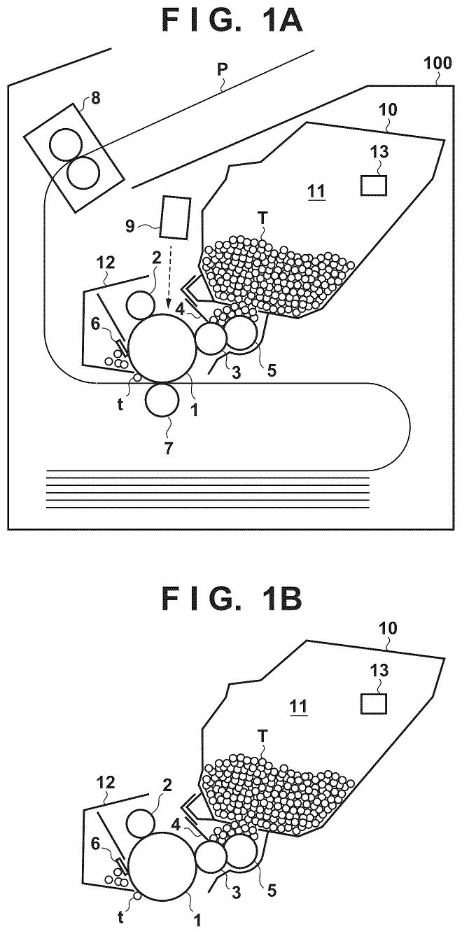

According to FIG. 1A, an image forming apparatus 100 is a printer that forms an image on a sheet P using an electrophotographic method. The sheet P may also be called a “transfer material”. FIG. 1B illustrates a process cartridge 10 removed from the image forming apparatus 100.

A photosensitive drum 1 is an image carrier rotationally driven by a motor. A charging roller 2 is a charging member that charges the surface of the photosensitive drum 1. The charging roller 2 is a charging member that controls the surface potential of the photosensitive drum 1 to a predetermined potential by applying a negative-polarity charging voltage at a predetermined timing. An exposure light source 9 is an exposure device (an optical scanning device) that irradiates the surface of the charged photosensitive drum 1 with light according to image data and forms an electrostatic latent image. The exposure light source 9 has an exposure amount that serves as a reference. A developing roller 3 is a developing agent carrier (developing member) that develops the electrostatic latent image using a developing agent T (called “toner” hereinafter) held in a receptacle 11 and causes the toner to adhere to the surface of the photosensitive drum 1 to form a toner image. A developing blade 4 is disposed to contact the developing roller 3 at a predetermined pressure. The developing blade 4 regulates the toner T supplied by a supply roller 5 from the receptacle 11 to the developing roller 3 to keep a toner layer formed on the developing roller 3 at a constant thickness. A developing voltage is applied to the developing roller 3. As a result, the toner moves from the developing roller 3 toward the photosensitive drum 1, and a toner image (a developing agent image) is formed. When the photosensitive drum 1 rotates, the toner image is transported to a contact area (a nip area) between a transfer roller 7 and the photosensitive drum 1. The toner image is transferred from the photosensitive drum 1 to the sheet P as the sheet P passes through the nip area. Here, a transfer voltage is applied to the transfer roller 7, which is a transfer member, to facilitate the transfer of the toner image. The sheet P onto which the toner image has been transferred is then transported to a fixing device 8. The fixing device 8 has two rotating bodies (e.g., a hollow cylindrical heating film and a solid cylindrical pressure roller). As the sheet P passes through the fixing device 8, heat and pressure are applied to the sheet P and the toner image. The toner image is fixed onto the sheet Pas a result. A cleaning blade 6 collects toner T that has not been transferred to the sheet P, and which therefore remains on the photosensitive drum 1, into a collection receptacle 12.

The process cartridge 10 is formed by integrating the photosensitive drum 1, the charging roller 2, the developing roller 3, the receptacle 11, the developing blade 4, the supply roller 5, the cleaning blade 6, the collection receptacle 12, and a storage device 13. The process cartridge 10 can be attached to and removed from the main body of the image forming apparatus 100. The storage device 13 is a non-volatile memory (storage medium) that stores image forming conditions and the like, for example.

In this manner, the process cartridge 10 is formed from a plurality of members (parts). The properties (e.g., quantity or function) of each of the plurality of members change as the members are used. For example, the amount of the toner T decreases each time an image is formed. The thickness of the surface layer of the photosensitive drum 1 decreases due to friction between the surface layer and the cleaning blade 6. The lifespans of these members are shorter than the lifespan of the main body of the image forming apparatus 100. A user can therefore continue using the image forming apparatus 100 by replacing the old process cartridge 10 with a new process cartridge 10.

From the standpoint of effective resource utilization and protecting the global environment, used process cartridges 10 are collected by recycling companies. A collected process cartridge 10 is processed for reuse by the manufacturer (primary company or secondary company) of the process cartridge 10, and is then sold as a recycled process cartridge. Alternatively, the collected process cartridge 10 is crushed, and the fragments are sorted and then recycled.

### 2. Storage Device

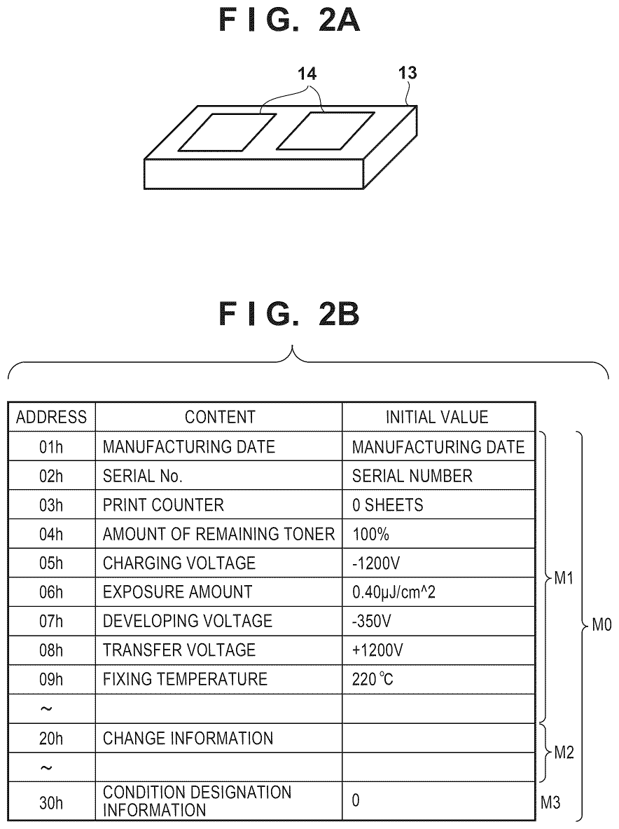

FIG. 2A illustrates the storage device 13. The storage device 13 is a semiconductor memory such as an Electrically Erasable Programmable Read-Only Memory (EEPROM) or the like, for example. The storage device 13 is packaged in a predetermined shape covered with a resin. The storage device 13 further includes an electrical contact 14 for wired communication with the main body of the image forming apparatus 100. The contact 14 may be an antenna for wireless communication (wireless connection) with the main body of the image forming apparatus 100.

FIG. 2B illustrates the content stored in the storage device 13. A plurality of addresses are assigned to a storage area M0, and predetermined information is stored in association with the plurality of addresses.

The storage area M0 includes storage areas M1, M2, and M3. The storage area M1 stores image forming conditions, which are important control parameters necessary for outputting a favorable image. The image forming conditions include, for example, charging voltage, exposure amount, developing voltage, transfer voltage (or transfer current), fixing temperature, and the like. Furthermore, the storage area M1 stores the manufacturing date, serial number, print counter, an amount of remaining toner, and the like of the process cartridge 10. The storage area M2 is an area that stores other image forming conditions different from the default image forming conditions stored in the storage area M1 (i.e., change information). When the process cartridge 10 is processed for reuse, the appropriate image forming conditions for that process cartridge 10 may change. In this case, the image forming conditions suited to the reused process cartridge 10 are stored in the storage area M2. The storage area M3 is an area that stores identification information used when the image forming apparatus 100 is operating. For example, the storage area M3 may store condition designation information indicating whether the image forming conditions stored in the storage area M1 are to be used or whether the image forming conditions stored in the storage area M2 are to be used. “0” is stored in the storage area M3 when the image forming conditions stored in the storage area M1 are to be used. However, “1” is stored in the storage area M3 when the image forming conditions stored in the storage area M2 are to be used.

The image forming apparatus 100 sends a read request/write request designating a desired address to the storage device 13. As a result, the image forming apparatus 100 reads desired information from the storage device 13, writes the desired information to the storage device 13, and the like.

### 3. Recycling System (Image Forming System, Management System)

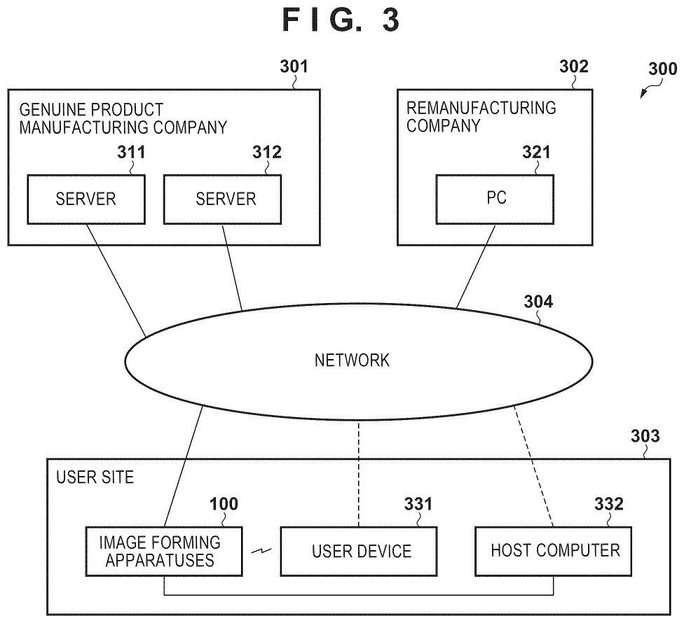

A primary company 301 indicated in a recycling system 300 illustrated in FIG. 3 is a company that designs and manufactures the image forming apparatus 100 and the process cartridge 10. A secondary company 302 is a company that manufactures recycled process cartridges by repairing (processing for reuse) the process cartridges 10 collected from users. A user site 303 is the site of the user who uses the image forming apparatus 100. “Processing for reuse” may also be called “recycling processing” or “remanufacturing”.

The primary company 301 has computers assigned names of “servers 311 and 312”. The servers 311 and 312 may be a single computer. The secondary company 302 has a personal computer (PC) 321. The user site 303 has the image forming apparatus 100, a user device 331, and a host computer 332. The PC 321 can communicate with the server 311 over a network 304. The network 304 is a collection of networks such as a local area network (LAN), a wide area network (WAN), a cellular network, and the like. The server 311 can also communicate with the server 312 over the network 304. The image forming apparatus 100 can also communicate with the server 312 over the network 304. The user device 331 is a smartphone, a tablet computer, a laptop computer, a desktop computer, or the like that can communicate wirelessly with the image forming apparatus 100. The user device 331 can also communicate with the servers 311 and 312 over the network 304. The host computer 332 is a computer that transmits print jobs to the image forming apparatus 100.

The server 311 determines image forming conditions on the basis of the characteristics of the recycled process cartridge, provided by the PC 321 of the secondary company 302, and saves the image forming conditions in the server 312. The user device 331 reads identification information given to the recycled process cartridge or the packaging box thereof and sends the reading result to the server 312. The server 312 sends the image forming conditions corresponding to the reading result to the user device 331. The user device 331 writes to the storage device 13 of the image forming apparatus 100. In other words, the image forming apparatus 100 receives the image forming conditions from the server 312 via the user device 331. Alternatively, when a recycled process cartridge is attached, the image forming apparatus 100 downloads the image forming conditions corresponding to the process cartridge from the server 312 and writes the image forming conditions to the storage device 13.

### 4. Control of Image Forming Apparatus

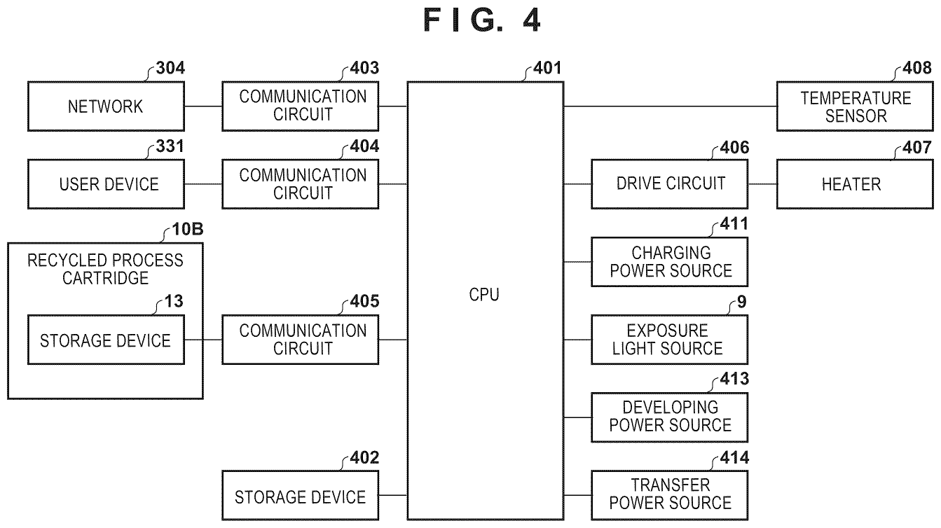

FIG. 4 illustrates a controller of the image forming apparatus 100. A CPU 401 executes control programs stored in a storage device 402 to control the image forming apparatus 100. The storage device 402 includes a read-only memory (ROM), a random access memory (RAM), a solid-state drive (SSD), a hard disk drive (HDD), or the like.

A communication circuit 403 is a communication circuit for communicating with the server 312 over the host computer 332 or the network 304 (e.g., a LAN card). A communication circuit 404 is a communication circuit for communicating with the user device 331 (e.g., a close-range wireless communication circuit, a short-range wireless communication circuit, or a wireless LAN card). A communication circuit 405 is a read/write circuit that writes information to the storage device 13 of the process cartridge 10 or a recycled process cartridge 10B, reads out information from the storage device 13, and the like. The communication circuit 405 has a contact or terminal electrically connected to the contact 14. When power is supplied from a commercial power source and the image forming apparatus 100 starts up, the CPU 401 accesses the storage device 13 through the communication circuit 405 and reads out the image forming conditions from the storage device 13.

A drive circuit 406 is a circuit that supplies power to a heater 407 of the fixing device 8. On the basis of a temperature sensor 408, the CPU 401 detects the temperature of the heater 407 and controls the drive circuit 406 to bring the temperature to a target temperature (a fixing temperature). A charging power source 411 generates a charging voltage designated by the CPU 401 and supplies the charging voltage to the charging roller 2. The CPU 401 controls the exposure light source 9 to emit light at the exposure amount mentioned earlier. The exposure light source 9 is a semiconductor laser or an organic electroluminescence-type light-emitting diode, for example. A developing power source 413 generates a developing voltage designated by the CPU 401 and supplies the developing voltage to the developing roller 3. A transfer power source 414 generates a transfer voltage designated by the CPU 401 and supplies the transfer voltage to the transfer roller 7.

### 5. Reuse Processing

Here, a process cartridge 10A newly manufactured by the primary company 301 is used by a user. The used process cartridge 10A is then collected by the secondary company 302, which is different from the primary company 301. The secondary company 302 processes the process cartridge 10A for reuse, manufactures the recycled process cartridge 10B, and sells the recycled process cartridge 10B on the market.

### 5-1. Details of Reuse Processing

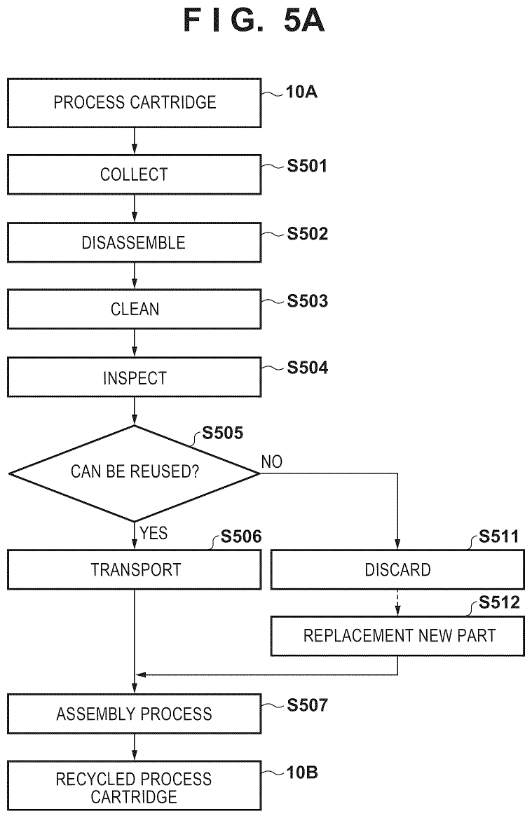

FIG. 5A illustrates the flow of typical reuse processing. The secondary company 302 collects the process cartridge 10A on the market (step S501). The secondary company 302 disassembles the collected process cartridge 10A into a plurality of parts (step S502).

The secondary company 302 cleans the plurality of parts (step S503). This cleaning process includes removing and cleaning toner remaining in the receptacle 11, and removing and cleaning out the toner T collected in the collection receptacle 12. The cleaning process may further include removing dirt adhering to the surface of the storage device 13, the charging roller 2, the developing roller 3, the developing blade 4, the supply roller 5, and the cleaning blade 6.

The secondary company 302 inspects each part (step S504) and determines whether each part can be reused (step S505). The inspection includes inspection to determine the degree of deterioration of the parts, such as visual inspection of the parts and inspection of the electrical properties of the parts. The details of the inspection can differ from part to part.

The secondary company 302 transports the parts determined to be reusable (reused parts) for a process for assembling the recycled process cartridge 10B (step S506). The secondary company 302 assembles the recycled process cartridge 10B using the reused parts (step S507).

On the other hand, the secondary company 302 discards parts determined not to be reusable (step S511). The secondary company 302 procures new parts to be used as replacements for the discarded parts and transports the new parts for assembly (step S512). The new parts may be replacement parts independently procured by a remanufacturing company B. In this manner, the secondary company 302 assembles the recycled process cartridge 10B using reused parts and replacement parts.

FIG. 5B illustrates specifications of the recycled process cartridge 10B manufactured by the secondary company 302. In this example, the toner T and the photosensitive drum 1 of the recycled process cartridge 10B are new parts (replacement parts) independently procured by the secondary company 302. The remaining parts of the recycled process cartridge 10B are parts that were part of the process cartridge 10A manufactured by the primary company 301 (reused parts).

### 5-2. Determining Image Forming Conditions for Recycled Process Cartridge

The storage device 13 mounted in the recycled process cartridge 10B had been mounted in the process cartridge 10A. As such, the image forming conditions stored in the storage device 13 are conditions suited to the process cartridge 10A manufactured by the primary company 301. The characteristics of the toner T contained in the recycled process cartridge 10B and the characteristics of the photosensitive drum 1 are likely to be different from those of the process cartridge 10A. It is therefore necessary to rewrite or add to the image forming conditions of the storage device 13 in accordance with the characteristics (specifications) of the recycled process cartridge 10B.

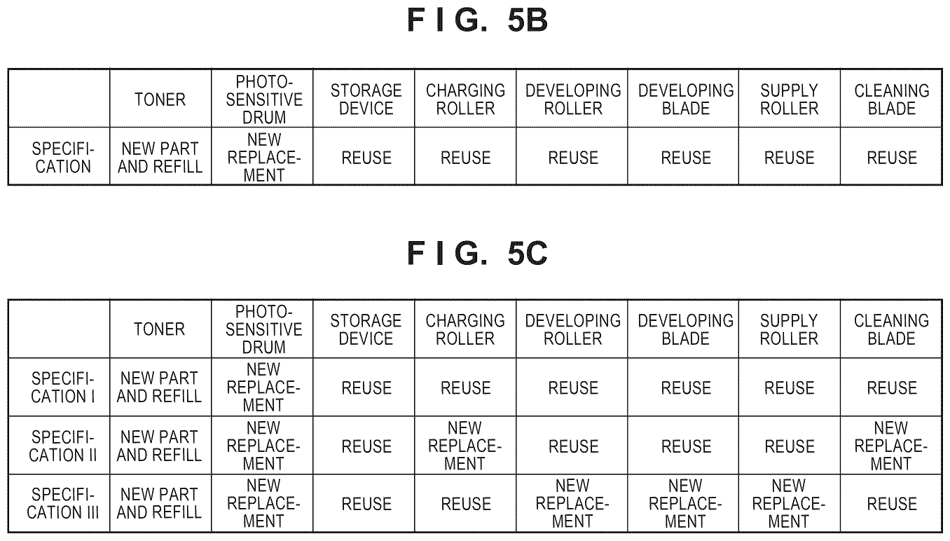

Accordingly, the secondary company 302 determines the image forming conditions for the recycled process cartridge 10B before selling the recycled process cartridge 10B on the market. It is necessary for the primary company 301 and the secondary company 302 to form an agreement in advance to determine the image forming conditions. FIG. 6 illustrates a method performed in the recycling system 300.

In step S601, the secondary company 302 in charge of remanufacturing the consumable submits a sales application to the primary company 301. The details of the application may include that the secondary company 302 sells the recycled process cartridge 10B, and that the secondary company 302 provides the determined image forming conditions to the recycled process cartridge 10B through the primary company 301. For example, the PC 321 accesses the server 311 over the network 304 and submits an application to sell and to provide the image forming conditions to the server 311. Here, the server 311 may be an email server or a web server.

In step S602, the primary company 301 receives the application from the secondary company 302 and determines whether to approve or reject the application. If the application is approved, the primary company 301 moves the sequence from step S602 to step S603. If the application is rejected, the primary company 301 does not provide setting range information necessary for the secondary company 302 to determine the image forming conditions, and the sequence ends. Note that the server 311 may send a response indicating the rejection to the PC 321.

In step S603, the primary company 301 sends the setting range information to the secondary company 302. The setting range information is a setting file indicating variable ranges of control parameters of the exposure light source 9, the charging power source 411, the developing power source 413, the transfer power source 414, and the fixing device 8 in the main body of the image forming apparatus 100 (the image forming conditions). The setting range information is as follows, for example.
Exposure light source 9: surface illumination on photosensitive drum 1=±0.05 to 0.7 μJ/cm²
Charging power source 411: charging voltage 0 V to −1800 V
Developing power source 413: developing voltage 0 V to −700 V
Transfer power source 414: transfer current 0 μA to 30 μA
Fixing device 8: fixing temperature 150° C. to 250° C.

The setting range information may be downloaded from the server 311 to the PC 321. The setting range information may be attached to an email sent from the server 311 to the PC 321. “Surface illumination” is the intensity of light on the surface of the photosensitive drum 1.

In step S604, the secondary company 302 examines the image forming conditions with reference to the setting range information. For example, the secondary company 302 attaches the recycled process cartridge 10B to the image forming apparatus 100 and outputs an image on a sheet P while adjusting the control parameters. The secondary company 302 views the output image.

In step S605, the secondary company 302 determines image forming conditions B0 suited to the recycled process cartridge 10B, and sends the image forming conditions B0 to the primary company 301. For example, the PC 321 sends the image forming conditions B0 to the server 311 over the network 304. The image forming conditions B0 may be uploaded from the PC 321 to the server 311. The image forming conditions B0 may be attached to an email sent from the PC 321 to the server 311. The image forming conditions B0 are determined as follows, for example.

### Specifications (Image Forming Conditions B0)

Exposure light source 9: surface illumination 0.37 μJ/cm²
Charging power source 411: charging voltage −1100 V
Developing power source 413: developing voltage −380 V
Transfer power source 414: transfer current 15 μA
Fixing device 8: fixing temperature 230° C.

In step S606, the primary company 301 (the server 311) generates write data for rewriting the data in the storage device 13. The write data includes the image forming conditions B0 to be written to the storage area M2 and the condition designation information to be written to the storage area M4.

In step S607, the primary company 301 (the server 311) registers the write data in the server 312 of the primary company 301.

### 5-3. Rewriting Image Forming Conditions

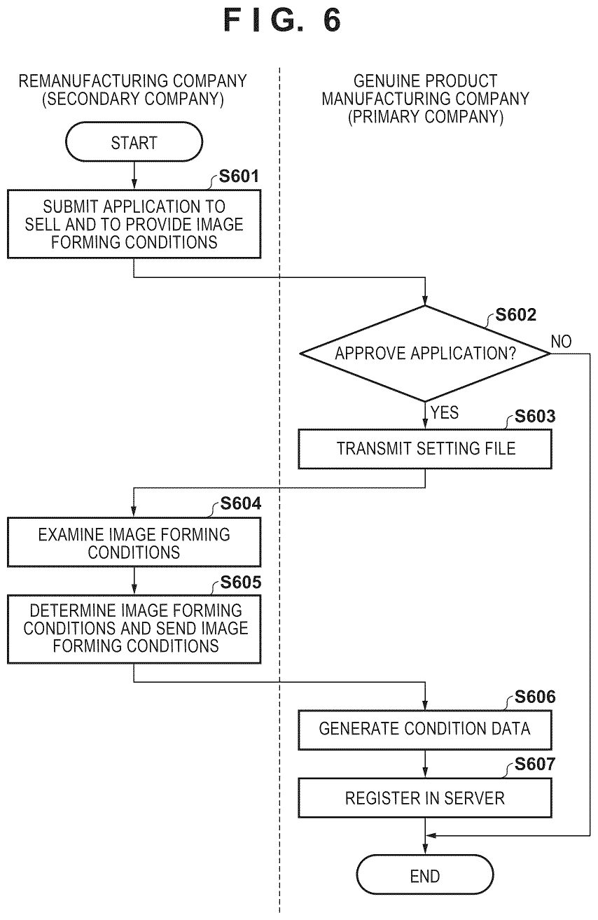

FIG. 7 illustrates a process from sale to use of the recycled process cartridge 10B. The secondary company 302 sells the recycled process cartridge 10B to a user on the market (step S701). The user purchases the recycled process cartridge 10B (step S702). The user attaches the recycled process cartridge 10B to the image forming apparatus 100 (step S703). The user obtains the image forming conditions for the recycled process cartridge 10B from the server 312, and writes the image forming conditions to the storage device 13 of the recycled process cartridge 10B. This writing may be performed when an image is formed on the first sheet P after the recycled process cartridge 10B is mounted in the image forming apparatus 100, for example.

The image forming apparatus 100 is connected to the server 312 over the network 304. The image forming apparatus 100 can be connected to the user device 331 capable of communicating with the server 312. As such, the image forming apparatus 100 can obtain the write data directly or indirectly from the server 312.

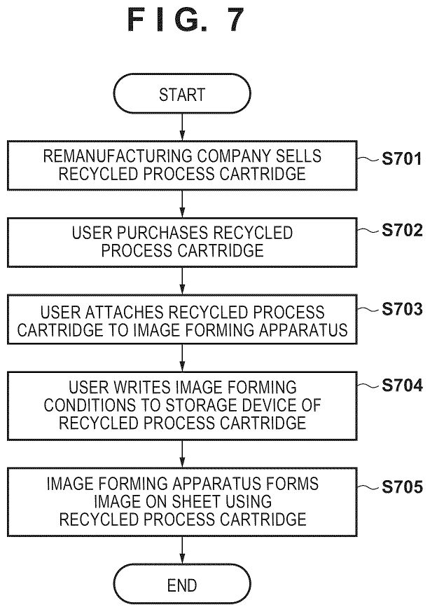

FIG. 8 illustrates an image forming condition writing sequence. In step S801, the primary company 301 (the server 311) issues an ID number N to the recycled process cartridge 10B of the remanufacturing company B. For example, the ID number N may be 13 numbers or letters. For example, the first to fifth characters from the left in the ID number N indicate identification information unique to each remanufacturing company (company identification information). The sixth to thirteenth characters from the left in the ID number N indicate identification information unique to the recycled process cartridge (distinguishing information). The company is identified by the ID number N because there may be a plurality of secondary companies 302 that wish to sell the recycled process cartridge 10B. The server 311 causes the ID number N to be stored in the server 312 in association with the image forming conditions B0 of the recycled process cartridge 10B.

In step S802, the primary company 301 (the server 311) sends the ID number N to the secondary company 302. The secondary company 302 (the PC 321) receives the ID number N from the server 311.

In step S803, the secondary company 302 (the PC 321) converts the ID number N into image information Q, such as a barcode or a two-dimensional code (converts the information into an image), and prints the image information Q onto a medium that can be affixed (an adhesive seal). Furthermore, the secondary company 302 sells the recycled process cartridge 10B after affixing a sticker on which the image information Q is printed to the exterior of the recycled process cartridge 10B, to packaging (e.g., a packaging box), or the like. Note that a paper medium onto which the image information Q is printed may instead be included in the packaging box.

In step S804, the user purchases the recycled process cartridge 10B. In step S805, the user reads the ID (the image information Q) affixed to the recycled process cartridge 10B using a reader or a camera provided in the user device 331. The user device 331 recovers the ID number N from the image information Q.

In step S806, the user mounts the recycled process cartridge 10B in the main body of the image forming apparatus 100, and turns the main body of the image forming apparatus 100 on.

In step S807, the user connects the user device 331 to the image forming apparatus 100 wirelessly, and transmits the ID number N from the user device 331 to the image forming apparatus 100.

In step S808, the image forming apparatus 100 sends the ID number N to the server 312 over the network 304. The ID number N may be included in a part of a request message for requesting the image forming conditions from the server 312. The server 312 receives the ID number N from the image forming apparatus 100.

In step S809, the server 312 determines whether the ID number N received from the image forming apparatus 100 is valid (authentication processing). For example, whether the received ID number N matches an ID number N already managed at the server 312 may be determined. If the ID number N is not valid (authentication failure), the server 312 sends an error response to the image forming apparatus 100. The image forming conditions B0 are not included in this response. However, if the ID number Nis valid (authentication success), the server 312 moves the sequence from step S809 to step S810.

In step S810, the server 312 obtains the image forming conditions B0 associated with the ID number N. In step S811, the server 312 sends the image forming conditions B0 and write permission (permission information) to the image forming apparatus 100 over the network 304. The image forming apparatus 100 receives the image forming conditions B0 and the write permission.

In step S812, the image forming apparatus 100 writes the image forming conditions B0 to the storage device 13 of the recycled process cartridge 10B. Specifically, the CPU 401 accesses the storage device 13 through the communication circuit 405 and writes the image forming conditions B0 to the storage area M2. Furthermore, the CPU 401 writes “1” to the storage area M3. The image forming conditions B0 are enabled as a result.

In step S813, the image forming apparatus 100 sends a completion notification, indicating that the rewrite of the image forming conditions has been completed, to the user device 331. Upon receiving the completion notification, the user device 331 notifies the user that the image forming apparatus 100 can print.

Note that the ID number N may be invalid, or there may be no image forming conditions B0 associated with the ID number N. In such a case, the image forming apparatus 100 receives an error response from the server 312. The image forming apparatus 100 then skips writing the image forming conditions to the storage device 13 of the recycled process cartridge 10B. In other words, the identification information stored in the storage area M3 is kept as “0”, and the image forming conditions for the process cartridge 10A are therefore enabled.

According to the first embodiment, the image forming conditions B0 suited to the recycled process cartridge 10B are written to the storage device 13. The image forming apparatus 100 can therefore form images on sheets P using the image forming conditions B0. This maintains the quality of the images formed on the sheets P. Additionally, the image forming conditions B0 suited to the recycled process cartridge 10B are used, and thus malfunctions in the image forming apparatus 100 caused by the recycled process cartridge 10B will be reduced.

Incidentally, the completion notification may be sent from the image forming apparatus 100 to the server 312. The server 312 may send a message indicating that the rewrite process is complete to the PC 321 of the secondary company 302. This enables the secondary company 302 to know that the image forming conditions B0 have been successfully written to the recycled process cartridge 10B.

Although the first embodiment assumes that only one secondary company 302 is present, this is merely one example. The ID number N includes the company identification information, and thus the first embodiment can be applied even when two or more secondary companies 302 are present. For example, secondary companies 302-1, 302-2, and 302-3 may provide recycled process cartridges 10B, 10C, and 10D, respectively. In this case, appropriate image forming conditions are provided for each of the recycled process cartridges 10B, 10C, and 10D. A unique ID number N is assigned to each of the image forming conditions and the recycled process cartridges 10B, 10C, and 10D, respectively.

### 6. Structure of PC, Servers, and User Device

### 6-1. Structure of Server 311

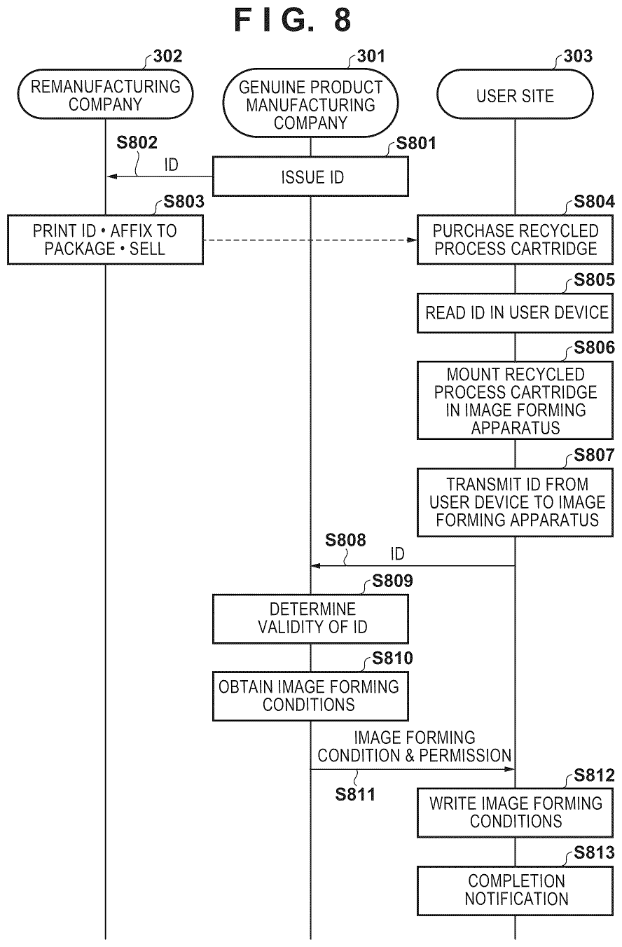

FIG. 9A illustrates the structure of the server 311 that processes the image forming condition registration application. A CPU 901 implements various functions by executing control programs stored in a storage device 902. Note that one or more of the plurality of functions implemented by the CPU 901 may be implemented by a hardware circuit such as an application-specific integrated circuit (ASIC) or a field-programmable gate array (FPGA). The storage device 902 can include a ROM, a RAM, an SSD, an HDD, or the like. A communication circuit 903 is a circuit for connecting to the network 304 and communicating with other computers. A keyboard 904 is an input device. A display 905 is a display device that displays information.

A reception unit 911 accepts the registration application sent from the PC 321 via the communication circuit 903. A file sending unit 912 sends a setting file, which indicates a range of image forming conditions that can be set, to the PC 321 through the communication circuit 903. A condition receiving unit 913 receives the image forming conditions B0 from the PC 321 through the communication circuit 903 and saves the image forming conditions B0 in the storage device 902. A creating unit 914 creates write data for writing the image forming conditions B0 to the storage device 13 and saves the write data to the storage device 902. An ID issuing unit 915 issues the ID number N for identifying the recycled process cartridge 10B, and stores the ID number N and the image forming conditions B0 in the server 312 in association with each other. The ID issuing unit 915 sends the ID number N to the PC 321 through the communication circuit 903.

### 6-2. Structure of Server 312

FIG. 9B illustrates the structure of the server 312 in charge of sending the image forming conditions. A CPU 921 implements various functions by executing control programs stored in a storage device 922. One or more of the plurality of functions implemented by the CPU 921 may be implemented by a hardware circuit such as an ASIC or a FPGA. The storage device 922 can include a ROM, a RAM, an SSD, an HDD, or the like. A communication circuit 923 is a circuit for connecting to the network 304 and communicating with other computers (e.g., the server 311, the PC 321, and the image forming apparatus 100). A keyboard 924 is an input device. A display 925 is a display device that displays information.

An ID receiving unit 931 communicates with the image forming apparatus 100 through the communication circuit 923 and receives the ID number N assigned to the recycled process cartridge 10B. As described above, the ID number N may be a part of a download request for the image forming conditions B0. An ID determination unit 932 determines whether the received ID number N is valid. For example, the ID determination unit 932 determines whether the received ID number N and the ID number N associated with the image forming conditions B0 in the storage device 922 match (a validity determination). A condition obtainment unit 933 obtains the write data of the image forming conditions B0 associated with the received ID number N from the storage device 922. A condition sending unit 934 sends the write data of the image forming conditions B0 to the image forming apparatus 100 via the communication circuit 923.

### 6-3. Structure of PC 321

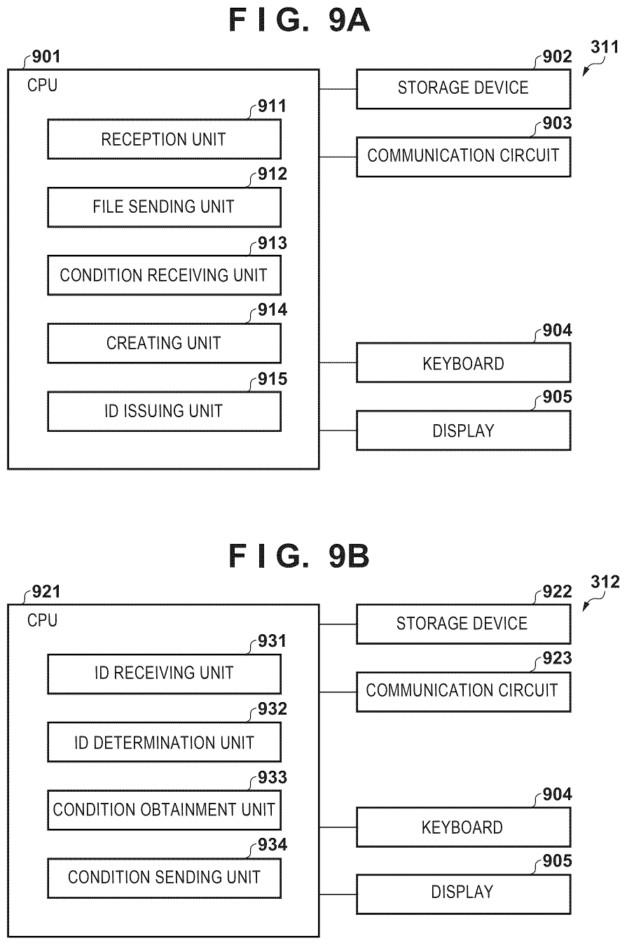

FIG. 10A illustrates the structure of the PC 321 in charge of registering the image forming conditions. A CPU 1001 implements various functions by executing control programs stored in a storage device 1002. One or more of the plurality of functions implemented by the CPU 1001 may be implemented by a hardware circuit such as an ASIC or a FPGA. The storage device 1002 may include a ROM, a RAM, an SSD, an HDD, or the like. A communication circuit 1003 is a circuit for connecting to the network 304 and communicating with other computers (e.g., the server 311). A keyboard 1004 is an input device. A display 1005 is a display device that displays information.

An application unit 1011 accesses the server 311 via the communication circuit 1003, and sends a registration application for the image forming conditions B0. A file receiving unit 1012 receives, from the server 311 via the communication circuit 1003, the setting file used to determine the image forming conditions B0, and saves the settings file to the storage device 1002. Note that the display 1005 may display a settable range for the image forming conditions denoted in the setting file. A condition determination unit 1013 determines the image forming conditions B0 on the basis of information input by the user using the keyboard 1004. A condition sending unit 1014 sends the image forming conditions B0 to the server 311 through the communication circuit 1003. An ID receiving unit 1015 receives the ID number N from the server 311 through the communication circuit 1003 and saves the ID number N in the storage device 1002. An ID printing unit 1016 converts the ID number into the image information Q, and controls a printer 1006 to print the image information Q onto a seal.

### 6-4. Structure of User Device

FIG. 10B illustrates the structure of the user device 331. A CPU 1021 implements various functions by executing control programs stored in a storage device 1022. One or more of the plurality of functions implemented by the CPU 1021 may be implemented by a hardware circuit such as an ASIC or a FPGA. The storage device 1022 can include a ROM, a RAM, an SSD, an HDD, or the like. A communication circuit 1023 is a circuit for connecting to the network 304 and communicating with other computers (e.g., the server 311, the server 312, and the PC 321). The communication circuit 1026 is a communication circuit that communicates according to a wireless communication standard such as Bluetooth (registered trademark), and communicates with the image forming apparatus 100. A camera 1027 has an image sensor used to read the image information Q. A touch sensor 1024 is an input device. A display 1025 is a display device that displays information.

A code reader 1031 controls the camera 1027 to capture the image information Q, and recovers the ID number N from the image information Q. An ID sending unit 1032 sends the ID number N to the image forming apparatus 100 via the communication circuit 1026. A notification receiving unit 1033 receives a write completion notification for the image forming conditions B0 from the image forming apparatus 100 through the communication circuit 1026. A notification display unit 1034 displays the write completion notification on the display 1025.

### 6-5. Functions of CPU of Image Forming Device

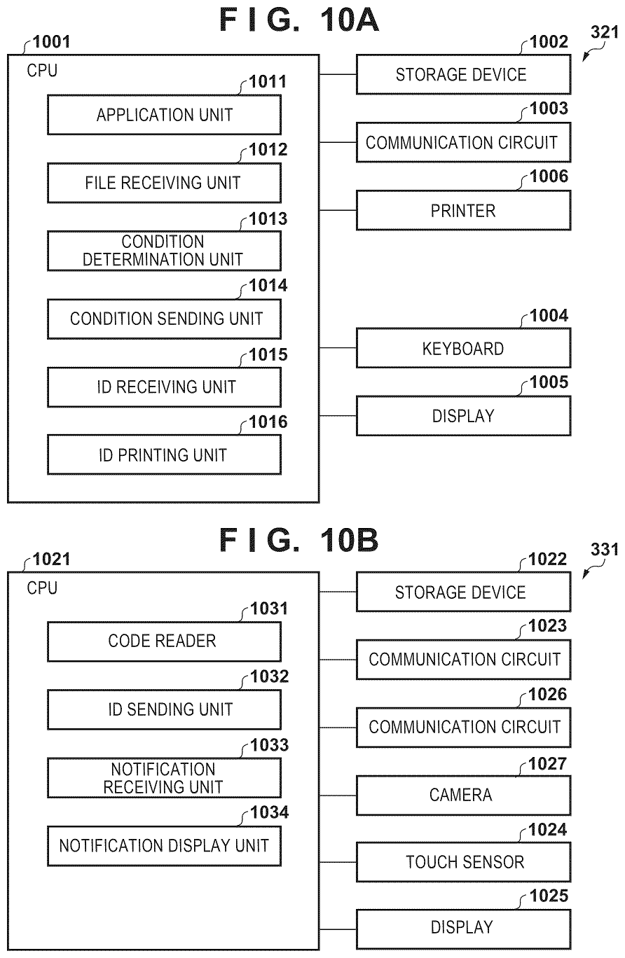

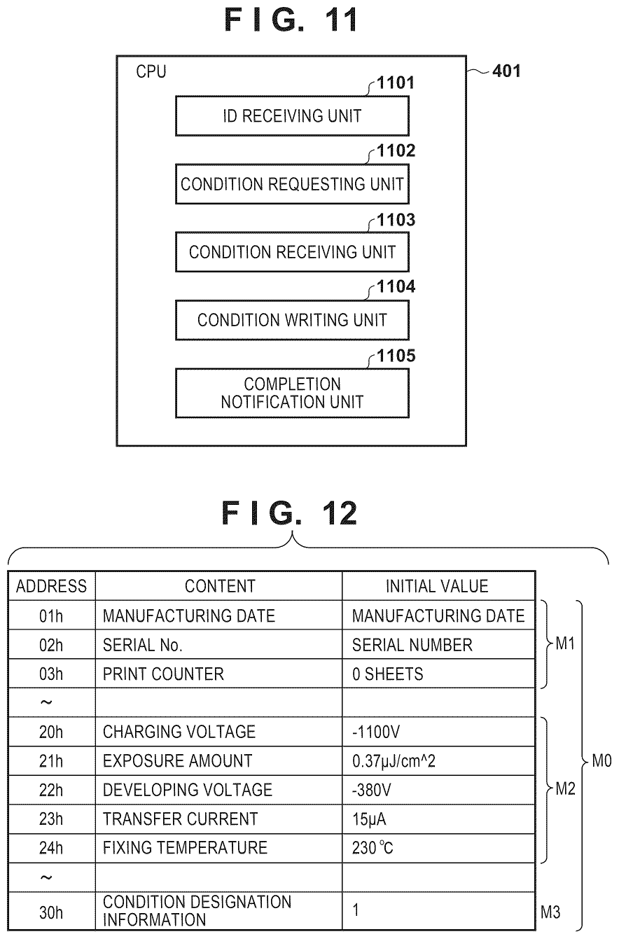

FIG. 11 illustrates functions implemented by the CPU 401. An ID receiving unit 1101 communicates with the user device 331 via the communication circuit 404 and receives the ID number N. A condition requesting unit 1102 sends a write request pertaining to the ID number N to the server 312 via the communication circuit 403. A condition receiving unit 1103 receives the write data of the image forming conditions B0, as well as the write permission, from the server 312 via the communication circuit 403 as a response to the write request. As illustrated in FIG. 12, a condition writing unit 1104 accesses the storage device 13 through the communication circuit 405 and writes the write data of the image forming conditions B0 to the storage area M2. Furthermore, the condition writing unit 1104 writes “1” to the storage area M3. A completion notification unit 1105 sends a completion notification to the user device 331 via the communication circuit 404.

### Second Embodiment

Although the first embodiment assumed that the specifications of the plurality of recycled process cartridges are all identical, this is merely one example. When repair parts applied to respective ones of a plurality of process cartridges of the same type are different, differences in characteristics (specifications) arise among the plurality of recycled process cartridges. Accordingly, a second embodiment proposes a reuse processing method and a sequence for writing image forming conditions for when at least two types of specifications for recycled process cartridges are present. In the second embodiment, descriptions of technical matters that are the same as or similar to the first embodiment will be omitted, with the descriptions focusing on the characteristic parts of the second embodiment.

### 1. Reuse Processing

As described with reference to FIG. 5A, the collected process cartridge 10 is disassembled, cleaned, and inspected to determine whether each part can be reused. Many parts are reused in order to utilize resources effectively, but some parts may not be reusable. In particular, the states of the charging roller 2, the developing roller 3, the developing blade 4, the supply roller 5, and the cleaning blade 6 may vary. The combination of reused parts and new parts therefore differs from recycled process cartridge 10B to recycled process cartridge 10B. As a result, two or more types of specifications may be present for the recycled process cartridges 10B.

As illustrated in FIG. 5C, for example, three different specifications, namely I, II, and III, may be present for the recycled process cartridges 10B remanufactured by the secondary company 302. In specification I, the toner T and the photosensitive drum 1 have been replaced with new ones. In specification II, the toner T, the photosensitive drum 1, the charging roller 2, and the cleaning blade 6 have been replaced with new ones. In specification III, the toner T, the photosensitive drum 1, the developing roller 3, the developing blade 4, and the supply roller 5 have been replaced with new ones. In this manner, when the three specifications I, II, and III are present, three appropriate image forming conditions can be present. Like the first embodiment, the image forming conditions are determined according to inspections by the secondary company 302, and are determined as follows, for example.

### Specification I (Image Forming Conditions B1)

Exposure light source 9: surface illumination 0.37 μJ/cm²
Charging power source 411: charging voltage −1100 V
Developing power source 413: developing voltage −380 V
Transfer power source 414: transfer current 15 μA
Fixing device 8: fixing temperature 230° C.

### Specification II (Image Forming Conditions B2)

Exposure light source 9: surface illumination 0.40 μJ/cm²
Charging power source 411: charging voltage −1300 V
Developing power source 413: developing voltage −380 V
Transfer power source 414: transfer current 15 μA
Fixing device 8: fixing temperature 230° C.

### Specification III (Image Forming Conditions B3)

Exposure light source 9: surface illumination 0.40 μJ/cm²
Charging power source 411: charging voltage −1300 V
Developing power source 413: developing voltage −400 V
Transfer power source 414: transfer current 15 μA
Fixing device 8: fixing temperature 230° C.

The ID issuing unit 915 of the primary company 301 assigns a unique ID number N to each of the sets of image forming conditions B1, B2, and B3 sent from the secondary company 302, and registers the unique ID numbers N in the server 312. Here, the ID number N can include unique identification information that distinguishes each individual company (e.g., five characters)+unique identification information that distinguishes each individual specification (e.g., three characters)+unique identification information that distinguishes each individual process cartridge (e.g., eight characters). The characters that form the ID number N may be numbers only, or may be a combination of numbers and letters. In this manner, the creating unit 914 creates the write data of the image forming conditions B1, B2, and B3, associates an identification number N with each item of write data, and stores the write data in the storage device 922.

### 2. Writing Image Forming Conditions

The condition obtainment unit 933 of the server 312 obtains the image forming conditions associated with the ID number N sent from the image forming apparatus 100 from the storage device 922. For example, if the ID number N relates to specification I, the image forming conditions B1 are obtained. If the ID number N relates to specification II, the image forming conditions B2 are obtained. If the ID number N relates to specification III, the image forming conditions B3 are obtained.

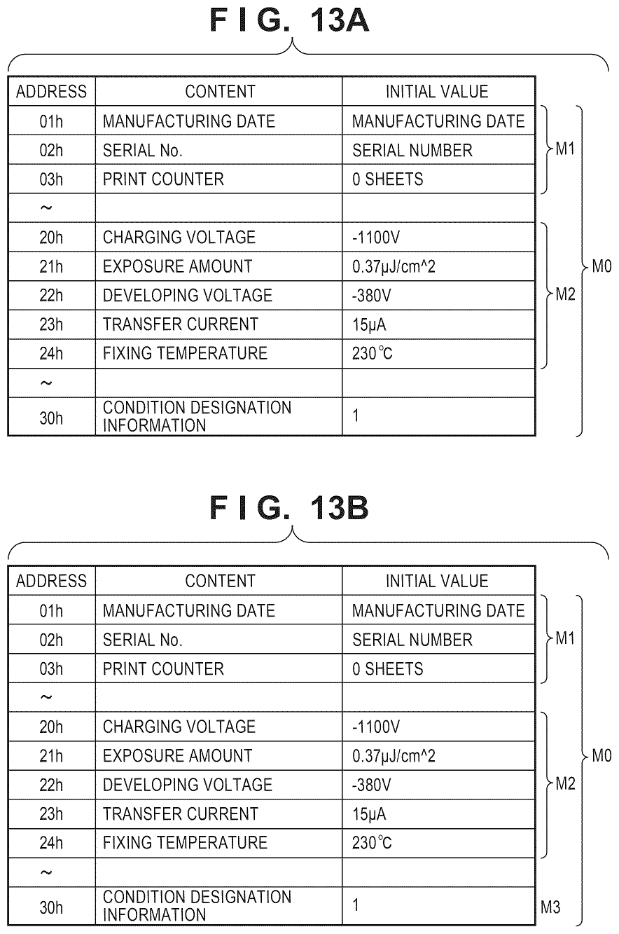

The condition writing unit 1104 of the image forming apparatus 100 rewrites the storage areas M2 and M3 in accordance with the write data received by the condition receiving unit 1103. When the write data of the image forming conditions B1 is received, the storage areas M2 and M3 are rewritten as illustrated in FIG. 12. When the write data of the image forming conditions B2 is received, the storage areas M2 and M3 are rewritten as illustrated in FIG. 13A. When the write data of the image forming conditions B3 is received, the storage areas M2 and M3 are rewritten as illustrated in FIG. 13B.

According to the second embodiment, even if a plurality of recycled process cartridge specifications are present, the image forming conditions suited to the corresponding specifications are written to the storage device 13. Accordingly, the image forming apparatus 100 can appropriately form images on sheets P using a recycled process cartridge 10B. Additionally, ensuring the image forming conditions are appropriate will reduce malfunctions in the image forming apparatus 100 caused by the recycled process cartridge 10B.

### Third Embodiment

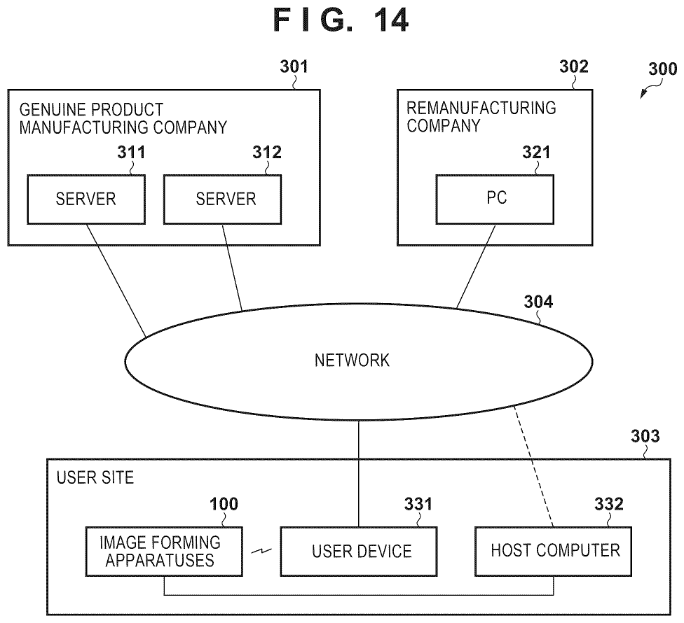

Although the first embodiment assumed that the image forming apparatus 100 can connect to the server 312, this is merely one example. As illustrated in FIG. 14, the image forming apparatus 100 may not be able to connect directly to the server 312. Accordingly, in the third embodiment, the image forming apparatus 100 obtains the image forming conditions of the recycled process cartridge 10B through the user device 331.

### 1. Writing Image Forming Conditions

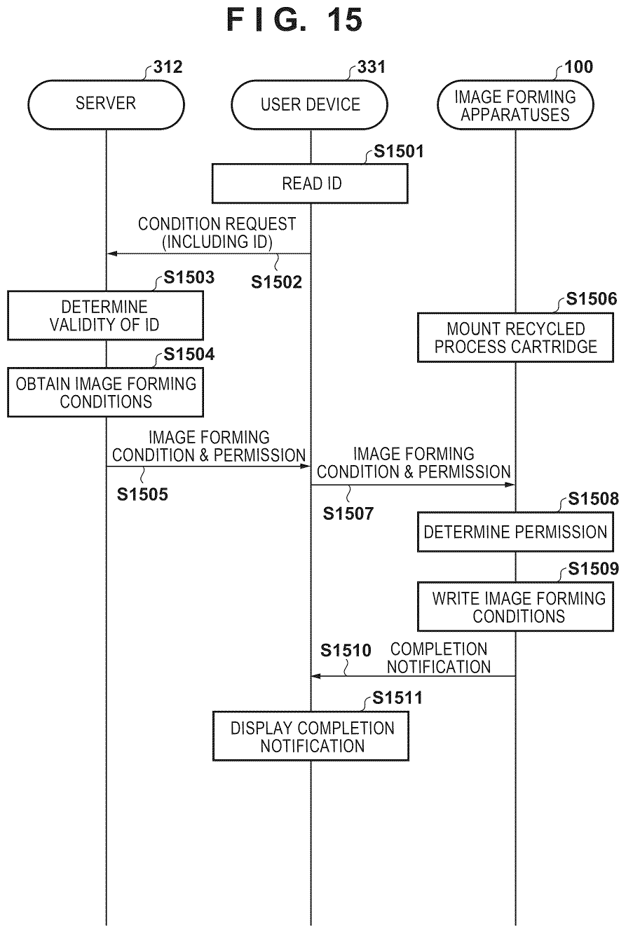

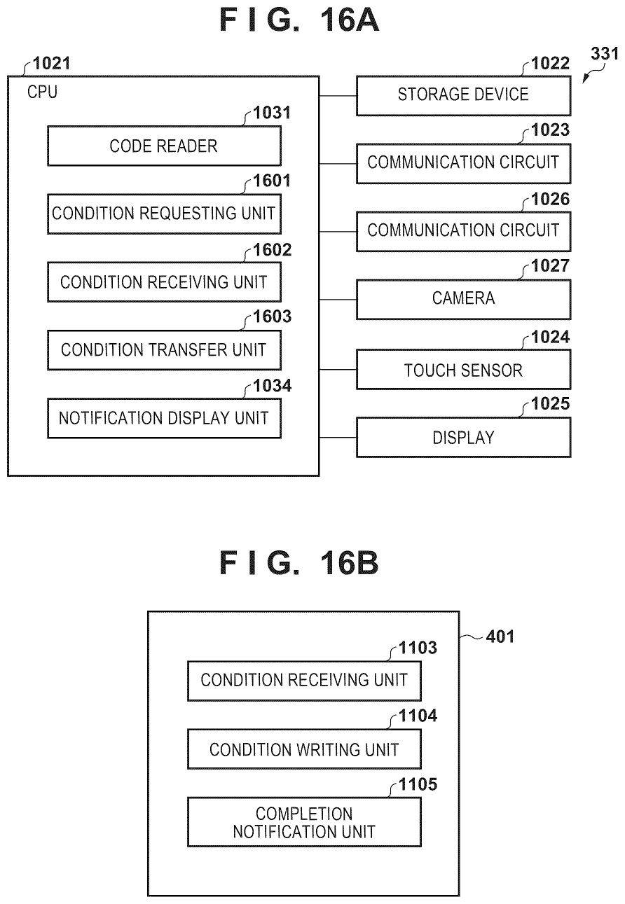

FIG. 15 illustrates an image forming condition writing sequence. FIG. 16A illustrates functions implemented by the CPU 1021 of the user device 331. FIG. 16B illustrates functions realized by the CPU 401 of the image forming apparatus 100. Compared to the first embodiment and the second embodiment, steps S807 to S813 are substituted as follows.

In step S1501, the code reader 1031 of the user device 331 controls the camera 1027 to capture the image information Q, and reads the ID number N by recovering the image information Q.

In step S1502, a condition requesting unit 1601 of the user device 331 creates a condition request including the ID number N, and sends the condition request to the server 312 via the communication circuit 1023. The ID receiving unit 931 of the server 312 receives the condition request including the ID number N from the user device 331 through the communication circuit 923.

In step S1503, the ID determination unit 932 of the server 312 determines the validity of the ID number N. If the ID number N is not valid, the ID determination unit 932 sends an error response to the user device 331. If the ID number is valid, the CPU 921 moves the sequence from step S1503 to step S1504.

In step S1504, the condition obtainment unit 933 of the server 312 obtains the write data of the image forming conditions B0 associated with the ID number N from the storage device 922.

In step S1505, the condition sending unit 934 sends the write data of the image forming conditions B0 and the write permission to the user device 331 via the communication circuit 923. A condition receiving unit 1602 of the user device 331 receives the write data of the image forming conditions B0 and the write permission through the network 304 and the communication circuit 1023.

In step S1506, the user mounts the recycled process cartridge 10B in the image forming apparatus 100.

In step S1507, a condition transfer unit 1603 of the user device 331 connects to the image forming apparatus 100 through the communication circuit 1026, and transfers the write data of the image forming conditions B0 and the write permission to the image forming apparatus 100. The condition receiving unit 1103 of the image forming apparatus 100 receives the write data and the write permission from the user device 331 via the communication circuit 404.

In step S1508, the condition writing unit 1104 of the image forming apparatus 100 determines whether write permission has been received. It is assumed here that rewriting is permitted.

In step S1509, the condition writing unit 1104 writes the image forming conditions B0 to the storage device 13. In other words, the condition writing unit 1104 rewrites the storage areas M2 and M3 on the basis of the write data.

In step S1510, the completion notification unit 1105 sends a completion notification to the user device 331 via the communication circuit 404. The notification display unit 1034 of the user device 331 receives the completion notification from the image forming apparatus 100 via the communication circuit 1026.

In step S1511, the notification display unit 1034 displays the completion notification on the display 1025.

Note that the user device 331 does not transfer the write data to the image forming apparatus 100 if an error response is received from the server 312. Accordingly, the image forming apparatus 100 uses the image forming conditions stored in the storage area M0 for the recycled process cartridge 10B.

According to the third embodiment, the image forming apparatus 100 can obtain the image forming conditions B0 for the recycled process cartridge 10B even if the image forming apparatus 100 cannot communicate with the server 312. Accordingly, the image forming apparatus 100 can appropriately form images on sheets P using a recycled process cartridge 10B. Additionally, ensuring the image forming conditions are appropriate will reduce malfunctions in the image forming apparatus 100 caused by the recycled process cartridge 10B.

### Fourth Embodiment

Although the first embodiment and the like described the image forming apparatus 100 installed at the user site 303 as rewriting the image forming condition, this is merely one example. In a fourth embodiment, the image forming apparatus 100 installed at the secondary company 302 writes the image forming conditions. Descriptions of the matters described in the first to third embodiments will be omitted from the fourth embodiment.

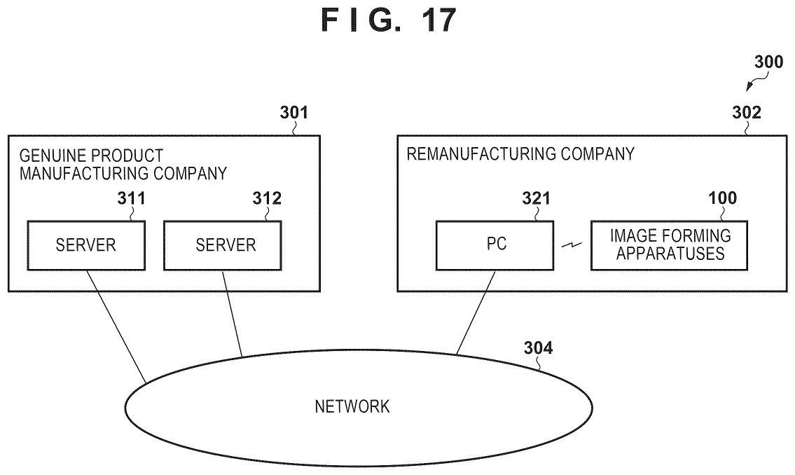

FIG. 17 illustrates the recycling system 300 according to the fourth embodiment. The secondary company 302 has the image forming apparatus 100 in addition to the PC 321 described above. The CPU 401 of the image forming apparatus 100 communicates with the PC 321 through the communication circuit 403 or the communication circuit 404.

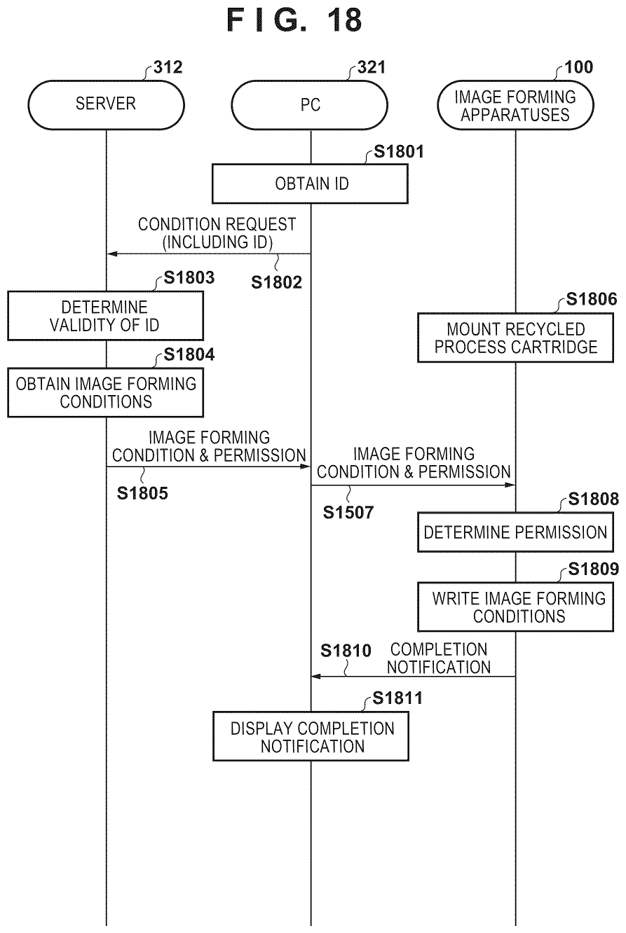

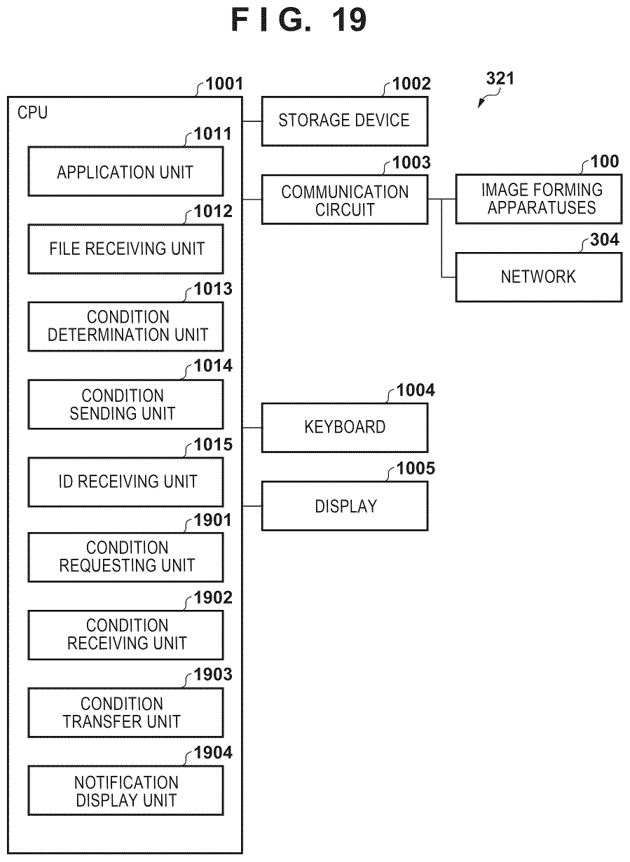

FIG. 18 illustrates an image forming condition writing sequence. FIG. 19 illustrates functions implemented by the CPU 1001 of the PC 321.

In step S1801, the CPU 1001 (an ID receiving unit 1015) of the PC 321 connects to the server 311 via the communication circuit 1003, and obtains the ID number N from the server 311.

In step S1802, a condition requesting unit 1901 of the PC 321 creates a condition request including the ID number N, and sends the condition request to the server 312 via the communication circuit 1003. The ID receiving unit 931 of the server 312 receives the condition request including the ID number N from the PC 321 through the communication circuit 923.

In step S1803, the ID determination unit 932 of the server 312 determines the validity of the ID number N. If the ID number N is not valid, the ID determination unit 932 sends an error response to the PC 321. If the ID number N is valid, the CPU 921 moves the sequence from step S1803 to step S1804.

In step S1804, the condition obtainment unit 933 of the server 312 obtains the write data of the image forming conditions B0 associated with the ID number N from the storage device 922.

In step S1805, the condition sending unit 934 sends the write data of the image forming conditions B0 and the write permission to the PC 321 via the communication circuit 923. A condition receiving unit 1902 of the PC 321 receives the write data of the image forming conditions B0 and the write permission through the network 304 and the communication circuit 1003.

In step S1806, the secondary company 302 mounts the recycled process cartridge 10B in the image forming apparatus 100.

In step S1807, a condition transfer unit 1903 of the PC 321 connects to the image forming apparatus 100 through the communication circuit 1003, and transfers the write data of the image forming conditions B0 and write permission to the image forming apparatus 100. The condition receiving unit 1103 of the image forming apparatus 100 receives the write data and the write permission from the PC 321 via the communication circuit 404.

In step S1808, the condition writing unit 1104 of the image forming apparatus 100 determines whether write permission has been received. It is assumed here that rewriting is permitted.

In step S1809, the condition writing unit 1104 writes the image forming conditions B0 to the storage device 13. In other words, the condition writing unit 1104 rewrites the storage areas M2 and M3 on the basis of the write data.

In step S1810, the completion notification unit 1105 sends a completion notification to the PC 321 via the communication circuit 404. The notification display unit 1034 of the PC 321 receives the completion notification from the image forming apparatus 100 via the communication circuit 1003.

In step S1811, the notification display unit 1034 displays the completion notification on the display 1005.

Note that the PC 321 does not transfer the write data to the image forming apparatus 100 if an error response is received from the server 312. Accordingly, the image forming apparatus 100 uses the image forming conditions for the process cartridge 10 for the recycled process cartridge 10B.

According to the fourth embodiment, the secondary company 302 can write the image forming conditions B0 to the storage device 13 of the recycled process cartridge 10B before selling the recycled process cartridge 10B to a user on the market. The user therefore need not perform tasks for reading the ID number N, downloading the image forming conditions, and rewriting the image forming conditions. In addition, even if the image forming apparatus 100 installed at the user site 303 cannot communicate with the server 312, the image forming apparatus 100 can obtain the image forming conditions B0 for the recycled process cartridge 10B. Accordingly, the image forming apparatus 100 can appropriately form images on sheets P using a recycled process cartridge 10B. Additionally, ensuring the image forming conditions are appropriate will reduce malfunctions in the image forming apparatus 100 caused by the recycled process cartridge 10B.

The server 312 may send one write permission per recycled process cartridge 10B. Through this, the server 312 may manage the number of recycled process cartridges 10B remanufactured by the secondary company 302.

Although the obtainment of the ID numbers N and the obtainment of the write data of the image forming conditions are performed separately in the foregoing embodiments, this is merely one example. The server 312 may send the ID number N and the write data of the image forming conditions to the image forming apparatus 100 at one time. In this case, the image forming apparatus 100 may recognize the ID number N as a write permission.

Additionally, in the foregoing embodiments, the secondary company 302 uses the image forming apparatus 100 to rewrite the image forming conditions of the storage device 13 provided in the recycled process cartridge 10B, but this is merely one example. For example, the secondary company 302 may connect a dedicated rewriting tool to the storage device 13 and write the write data of the image forming conditions B0 to the storage device 13.

### Fifth Embodiment

In the first embodiment and the like, it was necessary for the user to connect the user device 331 to the image forming apparatus 100. This task must be performed each time the process cartridge is replaced, and may be troublesome for the user. Accordingly, a fifth embodiment proposes reducing the user's work related to rewriting the image forming conditions by registering a username and the main body of the image forming apparatus with the primary company 301 in advance.

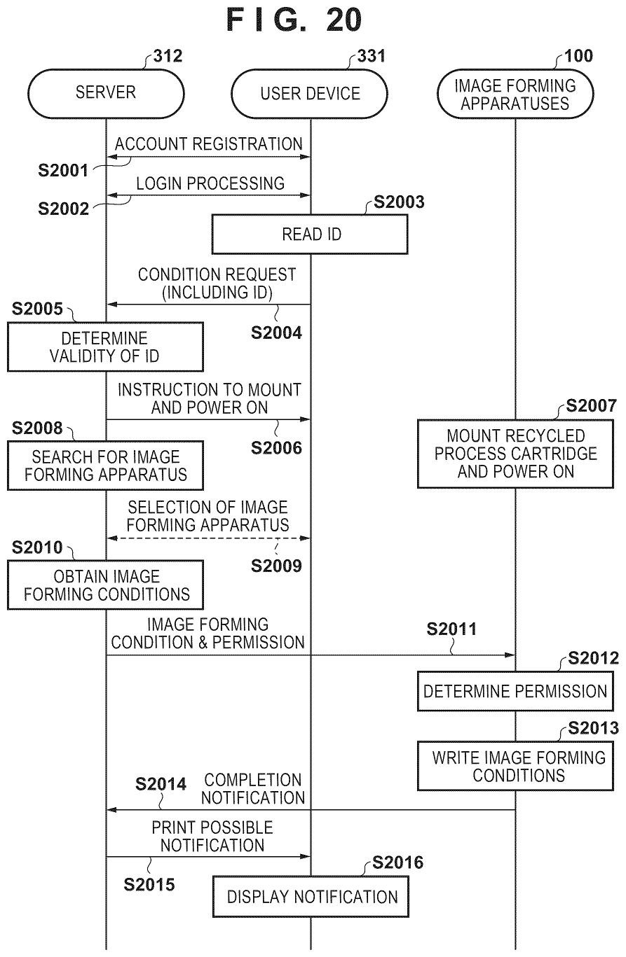

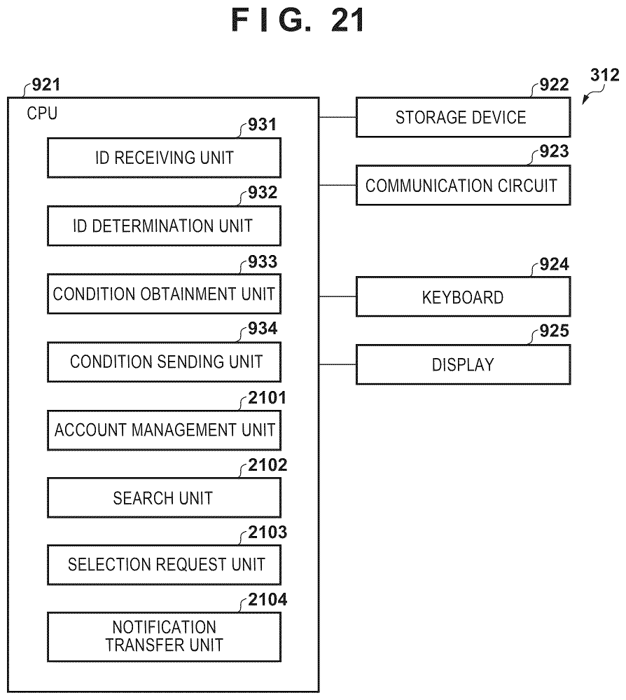

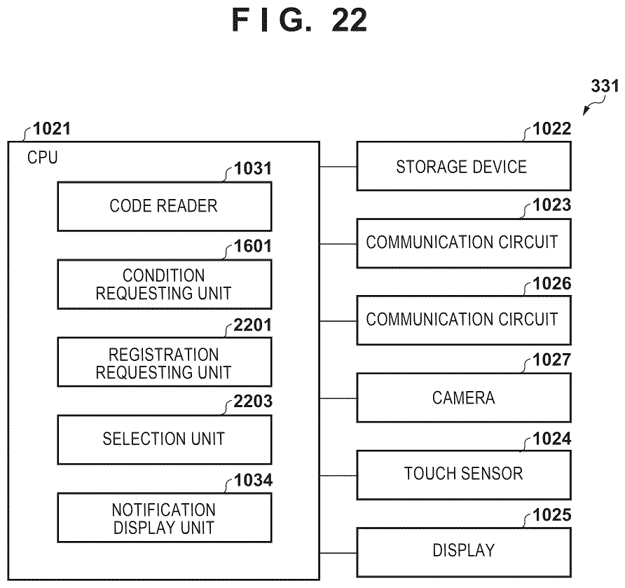

FIG. 20 illustrates the rewriting of the image forming conditions according to the fifth embodiment. FIG. 21 illustrates functions implemented by the CPU 921 of the server 312 according to the fifth embodiment. FIG. 22 illustrates functions implemented by the CPU 1021 of the user device 331 according to the fifth embodiment.

In step S2001, an account is registered between the user device 331 and the server 312. A registration requesting unit 2201 of the user device 331 accesses the server 312, and sends the name of the user (e.g., a login ID and a password) as well as unique identification information of the image forming apparatus 100 held by the user to the server 312. An account management unit 2101 of the server 312 writes the name of the user to the storage device 922 in association with the unique identification information of the image forming apparatus 100. Each time an image forming apparatus 100 held by the user is added or deleted, the unique identification information of the image forming apparatus 100 associated with the name of the user is updated. The unique identification information of two or more image forming apparatuses 100 may be associated with a single username. It is further assumed that the stated ID number N is also stored in the storage device 922 in association with the unique identification information of the image forming apparatus 100. Additionally, it is assumed that the user holds the recycled process cartridge 10B to which the image information Q of the ID number N has been affixed.

In step S2002, the CPU 1021 of the user device 331 logs in to the server 312. The account management unit 2101 of the server 312 permits the login on the basis of the user ID and password sent from the user device 331.

In step S2003, the CPU 1021 of the user device 331 reads the ID number N of the recycled process cartridge 10B. As described above, the code reader 1031 obtains the ID number N from the image information Q.

In step S2004, the condition requesting unit 1601 of the user device 331 sends a condition request pertaining to the ID number N to the server 312. The ID receiving unit 931 of the server 312 receives the condition request.

In step S2005, the ID determination unit 932 of the server 312 determines the validity of the ID number N received from the user device 331. It is assumed here that the ID number N is determined to be valid.

In step S2006, the CPU 921 of the server 312 sends an instruction to the user device 331. This instruction is an instruction for requesting the user to mount the recycled process cartridge 10B in the image forming apparatus 100 and power the image forming apparatus 100 on. Upon receiving the instruction, the CPU 1021 of the user device 331 causes the details of the instruction to be displayed on the display 1025.

In step S2007, the user mounts the recycled process cartridge 10B in the image forming apparatus 100, and powers the image forming apparatus 100 on. The condition receiving unit 1103 of the image forming apparatus 100 waits for the write data of the image forming conditions B0 to be sent from the server 312. Note that the condition receiving unit 1103 of the image forming apparatus 100 may send a condition request including its own unique identification information to the server 312. This will enable the server 312 to recognize which image forming apparatus 100 is active.

In step S2008, a search unit 2102 of the server 312 searches the storage device 922 on the basis of the ID number N received from the user device 331, and identifies the image forming apparatus 100 associated with the ID number N.

Step S2009 is executed when a plurality of image forming apparatuses 100 are found. In step S2009, a selection request unit 2103 of the server 312 sends a selection request for selecting an image forming apparatus 100 to the user device 331. The selection request includes identification information of the plurality of image forming apparatuses 100 discovered by the search unit 2102, and a message indicating that the user is to select one thereof. A selection unit 2203 of the user device 331 displays the identification information of the plurality of image forming apparatuses 100 on the display 1025 on the basis of the selection request, and accepts the selection of one thereof through the touch sensor 1024. The selection unit 2203 sends the identification information of the one image forming apparatus 100 selected by the user to the server 312.

In step S2010, the condition obtainment unit 933 of the server 312 obtains the write data of the image forming conditions B0 associated with the ID number N from the storage device 922.

In step S2011, the condition sending unit 934 of the server 312 connects to the server 312, and sends write data of the image forming conditions B0 and write permission to the image forming apparatus 100 selected by the user. The condition receiving unit 1103 of the image forming apparatus 100 receives the write data of the image forming conditions B0 and the write permission from the server 312.

In step S2012, the condition writing unit 1104 of the image forming apparatus 100 determines that writing the write data to the storage device 13 is permitted on the basis of write permission.

In step S2013, the condition writing unit 1104 of the image forming apparatus 100 rewrites the storage areas M2 and M3 of the storage device 13 on the basis of the write data.

In step S2014, the completion notification unit 1105 of the image forming apparatus 100 sends a completion notification, indicating that the writing of the image forming conditions B0 to the storage device 13 is complete, to the server 312. A notification transfer unit 2104 of the server 312 receives the completion notification from the image forming apparatus 100.

In step S2015, the notification transfer unit 2104 of the server 312 transfers a print possible notification to the user device 331. The notification display unit 1034 of the user device 331 displays the print possible notification on the display 1025. The print possible notification may be sent from the server 312 to the image forming apparatus 100 and displayed by the image forming apparatus 100.

Note that there are cases where the image forming apparatus 100 is not selected by the user, the image forming conditions B0 associated with the ID numbers N are not present, or the image forming apparatus 100 associated with the ID number N cannot be found. In such cases, the write data of the image forming conditions B0 and the write permission are not sent to the image forming apparatus 100. Accordingly, the image forming apparatus 100 does not rewrite the image forming conditions, and instead uses the image forming conditions stored in the storage area M1.

According to the fifth embodiment, an effect of reducing the workload on the user is achieved, in addition to the effects described in the first to fourth embodiments. Although the account registration is performed between the user device 331 and the server 312 in step S2001, this is merely one example. The account registration may be performed between the image forming apparatus 100 and the server 312. In this case, it is sufficient for the image forming apparatus 100 to have an input device (e.g., a panel-type touch sensor) and a display device.

### Other

The process cartridge 10 and the parts thereof are examples of a consumable. The transfer roller 7 and the like are an example of an image forming unit. The CPU 401 is an example of a controller. The storage device 13 is an example of a storage medium. The storage area M1 is an example of a first storage area. The storage area M2 is an example of a second storage area. In this manner, according to Item 1, the second image forming condition is stored in the second storage area, and thus the quality of the image formed by the image forming apparatus 100 is maintained even when the consumable is remanufactured by the secondary company 302. Furthermore, because the second image forming condition suited to the consumable is stored in the second storage area, the image forming apparatus is unlikely to malfunction. Furthermore, the first image forming condition for a genuine product is stored in the first storage area, and thus the first image forming condition can be used when the second image forming condition is not permitted to be used. The first image forming condition is an image forming condition for a genuine product. Because the secondary company 302 remanufactures the consumable using the genuine product as an objective, the image forming condition of the consumable is expected to be close to the first image forming condition. Accordingly, the first image forming condition is used when permission to use the second image forming condition is not obtained.

The communication circuits 403 and 404 are examples of receiving circuits. The communication circuit 405 is an example of a writing circuit. In this manner, the consumable and the image forming condition are associated with each other by the identification information, and the image forming condition corresponding to the consumable is therefore reliably written to the second storage area. Note that the ID number N is an example of the identification information.

The CPU 401 and the communication circuit 404 are an example of an obtainment unit. Note that an operation unit (a touch panel sensor) or a barcode reader connected to the CPU 401 may function as the obtainment unit. The communication circuit 403 is an example of a sending circuit.

Note that the identification information may be encoded in the image information Q (e.g., as a barcode or a two-dimensional code).

The identification information may be sent from the user device 331 to the server 312. The server 312 can obtain the identification information even if the image forming apparatus 100 cannot directly communicate with the server 312.

The image forming apparatus 100 can obtain the second image forming conditions even if the image forming apparatus 100 cannot directly communicate with the server 312.

The identification information may be sent to the server 312 via the user device 331. The server 312 can obtain the identification information even if the image forming apparatus 100 cannot directly communicate with the server 312.

The image forming apparatus 100 can obtain the second image forming conditions even if the image forming apparatus 100 cannot directly communicate with the server 312.

It will likely be easier for the user or the like to understand that the writing of the image forming condition has been completed and printing is possible. The completion notification may be transferred to the user device 331 via the server 312.

Explicit permission information may be sent with the second image forming condition. Note that the transmission of the second image forming condition itself may be recognized as implicit write permission.

There may be cases where the second image forming condition or the permission information cannot be obtained from the server. In this case, the first image forming condition is applied to the image forming unit. The first image forming condition for the genuine product is used as a result.

The company identification information will be useful in identifying the remanufacturer. The distinguishing information will make it easy to distinguish a plurality of consumables.

As described in the second embodiment, there may be a plurality of specifications for the consumables. In this case, the information for identifying the specifications of the consumables will be useful in distinguishing the plurality of specifications.

The transfer member (e.g., the transfer roller 7 or an intermediate transfer member) and the fixing device 8 are also components that affect the quality of images.

As described in the fourth embodiment, the second image forming condition may be written to the storage area M2 at the secondary company 302. This reduces the workload for the user.

The second image forming condition may be written immediately after the consumable is replaced.

The identification information (an implicit request for the second image forming condition) may be sent to the server immediately after the consumable is replaced.

The contact 14 functions as a communication unit. An antenna used instead of the contact 14 is also an example of a communication unit.

The second image forming condition is stored in the second storage area, and thus the quality of the image formed by the image forming apparatus 100 is maintained even when the consumable is remanufactured by the secondary company 302. Furthermore, because the second image forming condition is stored in the second storage area, the image forming apparatus is unlikely to malfunction. The request to write the image forming conditions B0 to the recycled process cartridge 10B may be sent from either the PC 321, the user device 331, or the image forming apparatus 100.

The server 312 may have a database that associates the image forming conditions B0 for the recycled process cartridge 10B with the secondary company 302 using identification information. The server 312 is managed by the primary company 301, and it is therefore difficult for incorrect image forming conditions to be written to the storage device 13 of the recycled process cartridge 10B.

The ID determination unit 932 functions as an authentication unit that executes authentication processing on the basis of the ID number N.

The second image forming condition is stored in the second storage area, and thus the quality of the image formed by the image forming apparatus 100 is maintained even when the consumable is remanufactured by the secondary company 302. Furthermore, because the second image forming condition is stored in the second storage area, the image forming apparatus is unlikely to malfunction.

Receiving the ID number N is an example of receiving the identification information of the consumable that is remanufactured. The authentication processing for the ID number Nis an example of processing for determining whether the second image forming condition is to be written to the storage medium.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-098976, filed Jun. 19, 2024 which is hereby incorporated by reference herein in its entirety.

What is claimed is:

1. An image forming apparatus comprising:
a consumable that can be attached to and removed from the image forming apparatus;
an image forming unit configured to form an image on a sheet using the consumable; and
a controller configured to control the image forming unit using an image forming condition read out from a storage medium provided in the consumable,
wherein the storage medium includes:
a first storage area configured to store a first image forming condition applied to the image forming unit before the consumable is remanufactured; and
a second storage area configured to store a second image forming condition that is written and applied to the image forming unit when the consumable is remanufactured.

2. The image forming apparatus according to claim 1,
wherein the controller is further configured to:
send identification information associated with the consumable that has been remanufactured to a server via a user device connected wirelessly to the image forming apparatus, the server holding the second image forming condition associated with the identification information associated with the consumable that has been remanufactured;
receive the second image forming condition from the server; and
write the second image forming condition to the second storage area.

3. The image forming apparatus according to claim 1,
wherein the storage medium further includes a third storage area configured to store information indicating which of the image forming condition stored in the first storage area and the image forming condition stored in the second storage area is valid, and
the controller is configured to apply the first image forming condition or the second image forming condition to the image forming unit on the basis of the information stored in the third storage area.

4. The image forming apparatus according to claim 2,
wherein the identification information associated with the consumable is issued in response to a remanufacturer who handles the remanufacturing of the consumable making an application to a manufacturer who manufactures the image forming apparatus.

5. The image forming apparatus according to claim 4,
wherein the identification information includes company identification information for identifying the remanufacturer and distinguishing information for distinguishing the consumable, and
the distinguishing information includes one or more of information for identifying each of individual consumables, each being the consumable, and information for identifying a specification of the consumable.

6. The image forming apparatus according to claim 2,
wherein the identification information is converted into an image and affixed to an exterior of the consumable or a packaging box of the consumable, or is packaged together with the consumable in the packaging box.

7. The image forming apparatus according to claim 1,
wherein the consumable is a process cartridge including one or more of a developing agent and a receptacle holding the developing agent.

8. The image forming apparatus according to claim 7,
wherein the process cartridge further includes one or more of a photosensitive member, a charging member that charges the photosensitive member, a developing member that forms a developing agent image by causing the developing agent to adhere to the photosensitive member, and a transfer member that transfers the developing agent image to a sheet.

9. The image forming apparatus according to claim 8,
wherein the image forming unit further includes a fixing unit configured to fix the developing agent image to the sheet, and
each of the first image forming condition and the second image forming condition includes one or more of a charging voltage supplied to the charging member, an intensity of light emitted onto the photosensitive member, a developing voltage supplied to the developing member, a transfer voltage or a transfer current supplied to the transfer member, and a fixing temperature applied to the fixing unit.

10. The image forming apparatus according to claim 1,
wherein the second image forming condition is stored in the second storage area by a company that remanufactured the consumable.

11. The image forming apparatus according to claim 3,
wherein the controller is further configured to:
obtain identification information associated with the consumable that has been remanufactured before forming an image on a first sheet using the consumable;
send the identification information to a server, the server holding the second image forming condition associated with the identification information associated with the consumable that has been remanufactured;
receive the second image forming condition from the server; and
write the second image forming condition to the second storage area.

12. A consumable for an image forming apparatus, the consumable comprising:
a communication circuit for communicating with the image forming apparatus; and
a storage medium connected to the communication circuit,
wherein the storage medium includes:
a first storage area configured to store a first image forming condition applied to the image forming apparatus before the consumable is remanufactured; and
a second storage area configured to store a second image forming condition that is written and applied to the image forming apparatus when the consumable is remanufactured.

13. A management system comprising:
an image forming apparatus; and
a server configured to manage a consumable,
wherein the image forming apparatus includes:
a consumable that can be attached to and removed from the image forming apparatus;
an image forming unit configured to form an image on a sheet using the consumable; and
a controller configured to control the image forming unit using an image forming condition read out from a storage medium provided in the consumable,
the storage medium includes:
a first storage area configured to store a first image forming condition applied to the image forming unit before the consumable is remanufactured; and
a second storage area configured to store a second image forming condition that is written and applied to the image forming unit when the consumable is remanufactured, and
the server computer comprises:
a storage device configured to store the second image forming condition; and
a processor configured to receive a request for the second image forming condition from one of the image forming apparatus, a user device, and a computer, and when the request is received, obtain the second image forming condition from the storage device and send the second image forming condition to the one of the image forming apparatus, the user device, and the computer, and
the second image forming condition sent from the server is written to the second storage area.

14. A server for managing a consumable for an image forming apparatus, the image forming apparatus including a consumable that can be attached to and removed from the image forming apparatus, an image forming unit configured to form an image on a sheet using the consumable, and a controller configured to control the image forming unit using an image forming condition read out from a storage medium provided in the consumable, and the storage medium including a first storage area configured to store a first image forming condition applied to the image forming unit before the consumable is remanufactured and a second storage area configured to store a second image forming condition that is written and applied to the image forming unit when the consumable is remanufactured, the server comprising:
a storage device configured to store the second image forming condition; and
a processor configured to receive a request for the second image forming condition from one of the image forming apparatus, a user device, and a computer, and when the request is received, obtain the second image forming condition from the storage device and send the second image forming condition to the one of the image forming apparatus, the user device, and the computer,
wherein the second image forming condition sent from the server is written to the second storage area.

15. A server for managing a consumable for an image forming apparatus, the image forming apparatus including a consumable that can be attached to and removed from the image forming apparatus, an image forming unit configured to form an image on a sheet using the consumable, and a controller configured to control the image forming unit using an image forming condition read out from a storage medium provided in the consumable, and the storage medium including a first storage area configured to store a first image forming condition applied to the image forming unit before the consumable is remanufactured and a second storage area configured to store a second image forming condition that is written and applied to the image forming unit when the consumable is remanufactured, the server comprising:
a communication circuit configured to receive identification information of the consumable that is remanufactured from one of the image forming apparatus, a user device, and a computer; and
a processor configured to determine whether the second image forming condition is to be written to the storage medium on the basis of the identification information,
wherein the communication circuit is configured to send the second image forming condition to the image forming apparatus when the processor determines that the second image forming condition is to be written to the storage medium, and
the second image forming condition sent from the server is written to the second storage area.
